(19) United States
(12) Patent Application Publication
(10) Pub. No.: US 2013/0173568 A1
(43) Pub. Date: Jul. 4, 2013

(54) METHOD OR SYSTEM FOR IDENTIFYING WEBSITE LINK SUGGESTIONS

(71) Applicants: Vanja Josifovski, Los Gatos, CA (US); Evgeniy Gabrilovich, Sunnyvale, CA (US); Bo Pang, Sunnyvale, CA (US); Fernando Diaz, San Franciso, CA (US); Jangwon Seo, Santa Clara, CA (US)

(72) Inventors: Vanja Josifovski, Los Gatos, CA (US); Evgeniy Gabrilovich, Sunnyvale, CA (US); Bo Pang, Sunnyvale, CA (US); Fernando Diaz, San Franciso, CA (US); Jangwon Seo, Santa Clara, CA (US)

(73) Assignee: YAHOO! INC., Sunnyvale, CA (US)

(21) Appl. No.: 13/339,142

(22) Filed: Dec. 28, 2011

(51) Int. Cl. G06F 17/30

(52) U.S. Cl. 707/706; 707/748; 707/749; 707/750; 707/751; 707/E17.108

(57) ABSTRACT

Methods and systems are provided that may be utilized to generate website link suggestions.

### BACKGROUND

1. Field

The subject matter disclosed herein relates to a method or system for identifying website link suggestions.

2. Information

Some individuals may exert time and effort searching for information of relevance on the Internet. Individuals may submit numerous queries to a search engine in an effort to find a web page relevant to a topic of interest. Likewise, individuals may locate a website containing relevant information, but may manually click on numerous links within a website to find a web page containing specific information of relevance. For example, even if an individual is able to locate a website for a particular movie theatre, the individual may click on certain links on the website to determine a particular time at which a movie of interest is playing.

Navigation link suggestion has been introduced as a tool for improving a user experience on a search engine results page presented to a user in response to the user submitting a search query via a search engine, for example. Finding information on the web may amount to finding the “right” Uniform Resource Locator (“URL”). Proactively suggesting navigation links that may be relevant to users'current information desires may therefore lead to higher user satisfaction, such as by allowing users to accomplish their goals or locate relevant information more quickly.

Navigation link suggestions may indicate web pages of interest for one or more websites or web documents linked on a search engine results page. However, a mechanism to assist users to locate information quickly continues to be desirable.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 illustrates one embodiment of an example of quick links determined for a web page listed in a search engine results page.

FIG. 2 illustrates a process for determining quick link candidates according to one or more implementations.

FIG. 3 illustrates a server according to an implementation; and

FIG. 4 is a schematic diagram illustrating a computing environment system that may include one or more devices to display web browser information according to one implementation.

### DETAILED DESCRIPTION

Reference throughout this specification to “one example”, “one feature”, “an example”, or “a feature” means that a particular feature, structure, or characteristic described in connection with the feature or example is included in at least one feature or example of claimed subject matter. Thus, appearances of the phrase “in one example”, “an example”, “in one feature” or “a feature” in various places throughout this specification are not necessarily all referring to the same feature or example. Furthermore, particular features, structures, or characteristics may be combined in one or more examples or features.

Embodiments of systems or methods are provided herein for determining navigation link suggestions to enhance a user experience for a user browsing the Internet or some other network. One or more quick links may be determined and presented to a user, for example. A “quick link,” as used herein, may refer to a link to a particular web page of a website. For example, a website may include numerous web pages. A website for the Chicago White Sox, for example, may include a homepage on which a welcome screen is displayed and may include various web pages on which statistics for individual players are shown, as well as team schedules, directions to the baseball stadium, information about the team's broadcast announcers, and so forth. A quick link may be presented to a user that indicates a shortcut or hotlink to items of particular relevance to a typical Internet user, such as links to popular players, or a team schedule, to name just two among many possible examples. A quick link may therefore present or otherwise provide a “quick” and relatively easy mechanism for a user to access items which may be of relevance to a user.

There may be various types of quick links, such as static quick links or dynamic quick links. A “static quick link,” as used herein may refer to a quick link determined, for example, so as to be presented to a user on a search engine results page. In one example, a static quick link may be determined and presented if a particular web page is listed as a search result. Of course, in an embodiment, a static quick link may be determined without being presented. In one example, the same quick links may be presented for a web page in a search engine results page regardless of a particular search query used by a user to locate the web page. In other examples, particular quick links may be dependent at least in part upon a particular formatting or wording of a search query submitted to find a particular web page in a search engine results page.

A “dynamic quick link,” as used herein may refer to a quick link determined and presented to a user browsing a web site. For example, a pop-up window may display dynamic quick links to various web pages of a web site that may be of interest to a user browsing the web site. In one example, a browser toolbar may display dynamic quick links. Dynamic quick links may be determined based at least in part on a current web page viewed by a user or a history of other web pages previously viewed by a user.

There are different ways in which quick links may be presented to a user. If, as discussed above, a user has submitted a search query via an Internet search engine, a search engine results page may be generated that indicates a ranked list of web pages or web documents of interest, for example. A “web page,” “web site,” or “web document,” as used herein may refer to code for a particular web page, such as source code, or to a web page itself. A web page may, for example, include embedded references to any form of content, including images, audio, video, other web documents, or any combination thereof, just to name a few examples. One common type of reference used to identify a location of resources on the web comprises a Uniform Resource Locator (URL).

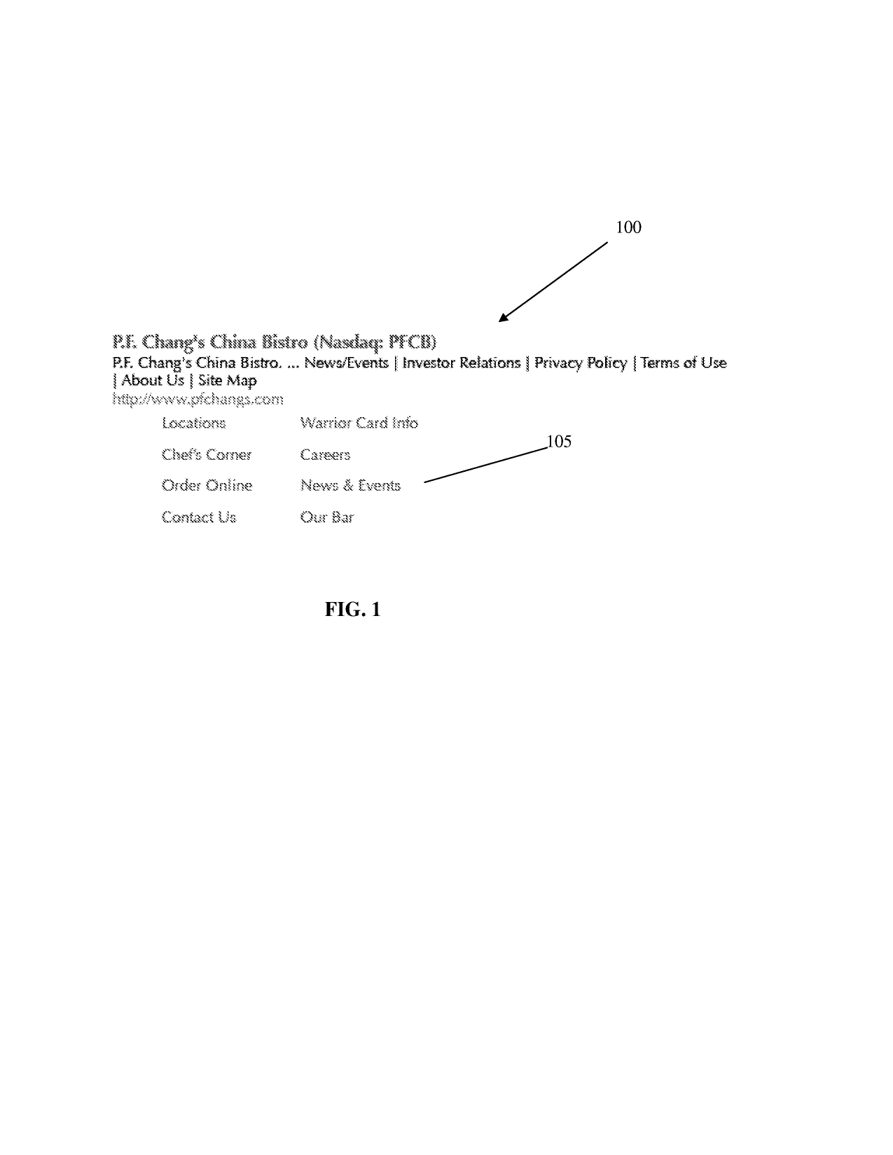

Quick links may be displayed on a search engine results page in immediate proximity to one or more web pages of the search engine results page, as one example. For example, if a user has searched for the Chicago White Sox, a ranked list of web pages relating to the Chicago White Sox may be identified and listed on a search engine results page. Quick links for web pages of interest within a website for the Chicago White Sox may also be determined and presented to a user. Similarly, if a user has searched for Chinese chain restaurants, a ranked list of web pages relating to the Chinese chain restaurants may be identified, for example, so as to be listed on a search engine results page. Quick links for web pages of interest within a website for a particular search result, such as the P.F. Chang's China Bistro restaurant may also be determined so as to be presented to a user as is discussed below with respect to FIG. 1.

In a web search scenario, static quick links may be generated for head or tail web sites. A “head website,” as used herein may refer to a web site for which historical user browsing information is known. For example, a head website may comprise a relatively commonly visited web site for which user browsing data is known. User browsing state or signal information may include user click-related information, again, in the form of signals or stored physical states, for example. For example, it may be known that users in the past have visited a particular web page of a website. Therefore, users in the present or future may also be likely to want to view the same web page, in which case a quick link for the web page may be determined and presented to a user.

A “tail website,” as used herein may refer to a web site for which historical user browsing signal or state information is unavailable. For example, a tail website may comprise a relatively new website or an otherwise rarely-visited website for which little or no historical user browsing signal or state information exists or is available.

To determine quick links for head or tail websites in a robust or efficient manner, various web sites may be categorized into one or more clusters to aggregate signal or state information across multiple sites. Clustering may enable relevant quick link suggestions for virtually any web site if so desired.

In response to receipt of a search query, a search engine may attempt to provide a URL to which it is expected that a user is more likely to desire to navigate. However, navigational queries may still have some amount of associated ambiguity. For example, if submitting a query, “P.F. Chang,” (e.g., to locate a web site for a chain of Chinese restaurants in the U.S.), a user may be interested in finding a nearby restaurant, checking a menu, booking a table, or ordering food for take-away. A search engine may not, by using conventional search technology, have an ability to determine a desired alternative given a short search query. A search engine may, however, provide quick links to web pages relating to options determined to be relevant to users, and may show quick links beneath a main URL for www.pfchangs.com on a search engine results page.

Quick links may be displayed on a search engine results page immediately proximate to one or more web pages of a search engine results page. For example, if a user has searched for a restaurant, such as “P.F. Chang's,” a ranked list of web pages relating to P.F. Chang's may be identified and listed on a search engine results page. Quick links for web pages of interest within a website for P.F. Chang's may also be determined and presented to a user.

FIG. 1 illustrates an example of quick links generated for a web page listed in a search engine results page according to one or more implementations. Of course, claimed subject matter is not limited in scope in this respect. As shown, a result 100 of a search engine query may comprise a homepage for P.F. Chang's China Bistro. Result 100 may include a link to a web page which was determined to be relevant to a search query. In this example, a web page for www.pfchangs.com is generated for a search query. Various quick links 105 to web pages within the P.F. Chang's website may also be presented. In this example eight quick links 105 are presented, although this is merely an illustrative example. For example, quick links 105 are provided for “Locations,” Warrior Card Info,” “Chef's Corner,” “Careers,” “Order Online,” “News & Events,” “Contact Us,” and “Our Bar.” It should be appreciated that quick links may comprise links to web pages which may be useful to a number of Internet users.

In some implementations, a process for quick link suggestion may utilize user selections or clicks logged via a web search toolbar to determine relevance. For example, a user may via web pages via a browser having a toolbar which may record or store user clicks—such user clicks may be utilized to infer topics or websites of interest to the user or other users. A “toolbar” or “web search toolbar,” as used herein may refer to an application for storing or otherwise recording user selections or user web browsing habits, for example.

“User click” and “user selection” may be used interchangeable herein to refer to a selection of a website link. For example, if a user browsing the Internet utilizes a computer mouse to click or select a link to visit a particular web page, information relating to such browsing or clicking activity may be logged such as via a web search toolbar. Similarly, a pre-fetching system may utilize site-level access logs to suggest links for pre-fetching. A site-level access log may refer to a log maintained for a particular web site that indicates some or all user clicks made for a particular web site. In an implementation, user browsing or clicking activity may be stored locally, such as, e.g., on a hard drive of a user's computer. Alternatively, or additionally, user browsing or clicking signal/state information may be stored remotely, such as in a server. Although these techniques may be adequate for web sites with sufficient traffic, performance may suffer if user click activity is scarce or does not exist at all. For example, quick links may be relatively simple to determine for a popular head site, such as restaurant chain “P.F. Chang's”, but sufficient traffic may not available for a tail website, such as “Tarzana Armenian Deli.” Unfortunately, sufficient traffic may be a luxury possessed by popular sites, whereas relatively low traffic may be common for other web sites.

One or more implementations address a lack of historical user click activity for tail web sites. To address this, a scope of link suggestion techniques, as discussed herein, may be broadened beyond traffic-type solutions. In a context of quick links, traffic-type models may be extended to include non-traffic indicators. For example, indicators based at least in part on page or site layout may be employed. Web sites may be clustered, for example, to leverage similarities between categories of sites. As one example, restaurant web sites may include a “menu” quick link. Together, techniques discussed herein may permit a system to generate quick link suggestions for a set of sites including tail websites, for example. In principle, a system may be capable of providing a quick link to virtually any web page, regardless of whether historical user click activity state or signal information is available.

A static quick links task, for example, may include selecting or ranking links for a user entering a web site. A static quick links task may be characterized by a set of sites, S. A site, s∈S, may have a set of candidate quick links, U(s). Set U(s) may include some, or even all, links contained on a web site's homepage p. For a u∈U(s), there may be an unobserved binary relevance donated as r(s)∈{0,1}. Given s∈S, a system may select or rank a set of k URLs from U(s) to make more apparent a latent relevance of the set of candidate quick links, U(s).

A dynamic quick links task may refer to conditioning a selection or ranking of k URLs on URL u′∈U(s) which a user is currently browsing. Dynamic quick links may be provided to assist in user browsing, potentially even anticipating which link a user may choose for a given web page.

One issue for implementing a link suggestion method or process may include query dependence. Choosing a query dependent route may be beneficial for Web search, as a query dependent route may use additional information contained in a query. However, a query dependent route may come at a cost, by increasing an amount of computation to be done for a submitted query. For search engines handling hundreds of millions of queries on a daily basis, increased computation may not always be desirable. Query independent approaches, on the other hand, may be more general and may also apply to browsing scenarios.

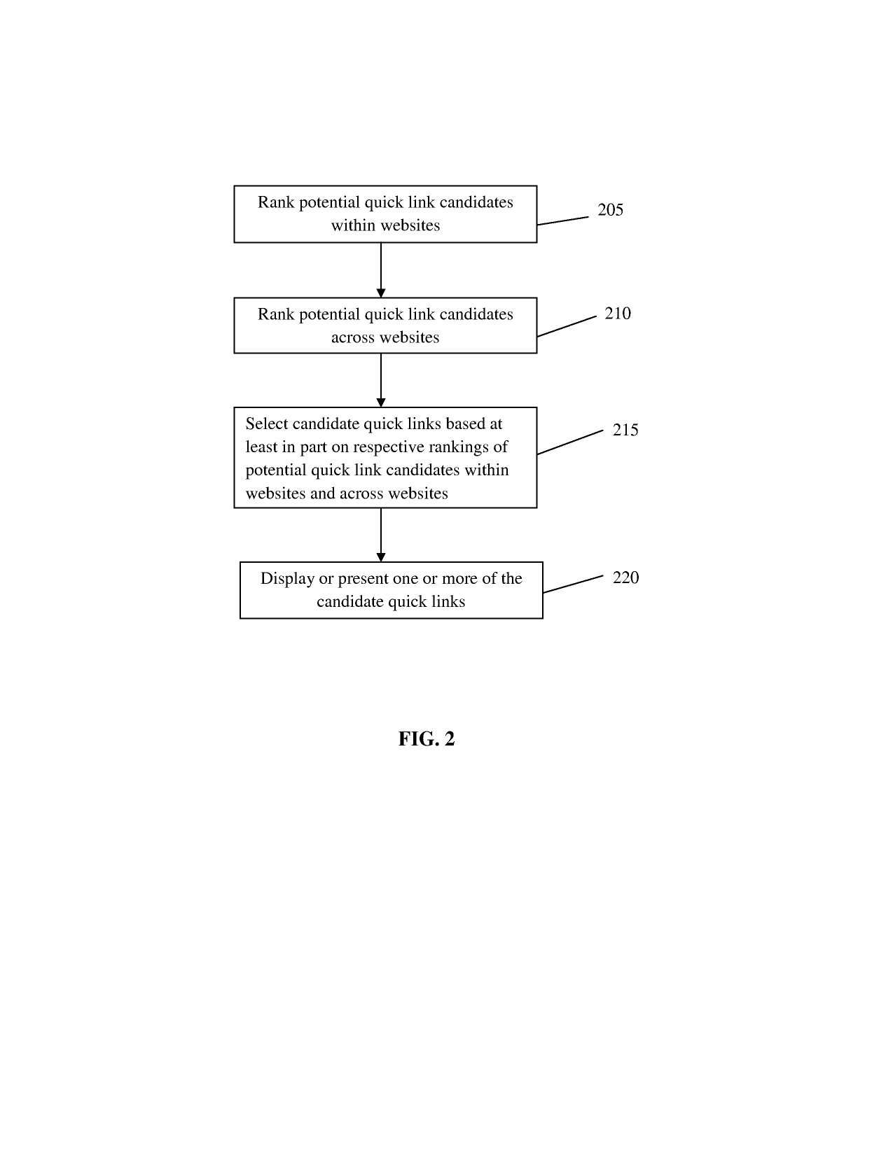

FIG. 2 illustrates a process 200 for determining quick link candidates according to one or more implementations. Embodiments in accordance with claimed subject matter may include all of, less than, or more than blocks 205-220. Also, the order of blocks 205-220 is merely an example order.

At operation 205, potential quick link candidates may be ranked within websites. For example, signal or state information about a website may be used to rank potential quick link candidates. At operation 210, potential quick link candidates may be ranked across websites. For example, a web site may be clustered with other relatively similar websites. Features of similar websites may be used to rank potential quick link candidates for a particular website. At operation 215, candidate quick links may be selected based at least in part on respective rankings of potential quick link candidates within websites and across websites. At operation 220, one or more candidate quick links may be displayed or otherwise presented to a user.

In at least one embodiment, a machine learning approach may be adopted to address a static quick links task. In general, a machine learning approach may determine or generate a relationship between a task instance and a desired target signal or state value. A “task instance,” as used herein, may refer to an instance of a particular task definition. A new task instance may be created if a particular kind of task is started, for example.

In a particular scenario, a u∈U(s) may refer to an instance. A desired target signal or state value of an instance may include a relevance, rₛ(u). To generalize, machine learning approaches may compute features of instances or may provide a relationship between features. Machine learning may be performed by using a small set of training instances which have labeled target signal or state values. “Machine learning,” as used herein may comprise a process for evaluating examples within a training set, for example, to capture characteristics of interest, such as underlying probability distribution(s), for example.

In an example, access to a set of sites S^{t}⊂S whose URLs have relevance values, rₛ(u) may be provided. An approach may employ signal or state information regarding how to compute instance features or how to describe a relationship to a target.

“Features,” as used herein, may refer to signal or state information for characterizing a web site. Features may be utilized to determine clustering of web sites relative to other web sites to access relevant quick links. Different types of features may be utilized for characterizing a web site, such as common features or head features, as discussed below.

Certain principles may be followed to determine or otherwise assess features. Features of u may correlate with rₛ(u), for example. Features which are adequately represented in head or tail sites may be utilized for performance reasons. Types of features which may be considered include common features or head features, for example.

“Common features,” as used herein, may refer to features sufficiently represented in head or tail web sites. For example, common features may be determined based at least in part on signal or state information contained in a URL for a website, extracted from anchor text, or determined from a Document Object Management (DOM) block for a web site, for example.

Anchor text may comprise one or more characters or words characterizing or indicating subject matter, such as a first web document, for example. Anchor text may also be included within a link, for example, such as on a second web document, where the link may also reference the first web document. If, for example, a second web document contains a link around a text phrase such as “car sales in Southern California,” which links back to the first web document, that phrase may therefore be considered anchor text for the first web document. Accordingly, anchor text may be associated with a first web document although such anchor text may not actually be contained within the first web document.

“Head features,” as used herein may refer to one or more features represented in one or more head web sites. Head features may, for example, be based at least in part on historical user selection or click signal/state information and may contain signal/state information about links, such as those of sites that may receive web traffic.

For a u∈U(s), at least in one embodiment three sets of common features may be generated, according to an implementation. For example, URL-type features may be extracted from a URL address of quick link u. Without limitation, URL-type features may include, for example, a depth of a URL path or a type of URL file extension (e.g., html, jpg, php), to name just two among many different possible examples of features. Anchor text-type features may be extracted from anchor text used for u in a homepage p of a web site, such as, for example, how many named entities are in anchor text w, how many nouns or verbs are in anchor text, and so forth. It should be noted that these are functions of text, rather than so called term features, as may be used with information retrieval or text classification. Anchor text features may, for example, be utilized to provide one or more generalizations across different types of sites in an least one embodiment.

As another illustrative example, DOM block-type features may be extracted from a DOM block b of homepage p to which a quick link u may belong, for example. DOM block-type features may include a ratio of bytes of text to a number of links in b or a position of b in a DOM block order, to name just a couple among possible examples. Therefore, any one of a variety of features is possible as common or head features if extractable, for example, so as to be capable of being generalized

For a candidate quick link, two sets of head features may be generated, for example. Link structure-type features may be extracted from hyper-link structures of a Web graph, for example, such as a number of incoming links to quick link u. User behavior-type features may be extracted from user behavior stored signal or state information regarding activity such as toolbar logs, e.g., indicating a number of visits to u over a certain period of time. Head features may be sparse or nonexistent for tail sites.

One or more features of a quick link u are referred to below as φᵤ^{s}. A relationship between a candidate quick link's features, φᵤ^{s} and its relevance, rₛ(u), may be generated in at least one implementation, for example. A regression analysis may be performed, for example. Evaluation may be performed, for example, to assess or capture a function h whose domain may comprise a web site and/or candidate quick link(s), with relevance range. “Relevance,” as used herein may refer to how closely related a candidate quick link is to a web site, in terms of hyperlink jump(s), for example. A training set error of h may also be measured as,

ε(h,S^{t})=Σ_{s∈S}^{^{t}}Σ_{u∈U(s)}(h(s,u)−rₛ(u))² [1]

An approach may be to select a function \tilde{h} such that

\tilde{h}_{c}=argmin_{h∈H}ε(h,S^{t}) [2]

An hypothesis space, H, may comprise a set of possible functions which fit a particular functional form. To perform “learning,” H may be generally characterized in a proposed form for evaluation.

For example, hεH may be treated as a decision tree forest composed of m trees such that,

h(s,u)=λ₀ƒ⁰(φᵤ^{s})+ . . . +λₘƒ^{m}(φᵤ^{s}) [3]

where ƒⁱ comprises a regression tree, φᵤ^{s} represents features generated for candidate u of site s, and λⁱ comprises a parameter controlling a contribution of ƒⁱ to a prediction. Regression trees may, for example, address numerical or categorical features and may be effective in connection with ranking tasks.

Friedman's Gradient Boosted Decision Tree (GBDT) process may be applied to search a space such as [2] for an hypothesis space that is NP-Complete. “Greedy function approximations: gradient boosting machine,” by J.H. Friedman, Annals of Statistics, 29, 2000, for example, discusses a possible approach. A GBDT process may, for example, search H using a boosting approach. A GBDT process may begin with an initial function ƒ⁰ that may comprise an average of labels of training signal or state samples. Subsequent trees, ƒⁱ, may iteratively reduce an L₂ loss with respect to residuals of signal sample values, such as predicted values or of target values. One or more signal sample value weights, wᵢ may in one possible embodiment comprise a monotonically decreasing function of i, parameterized by a sample value, n, referred to as a learning rate in this context. Another implementation may include other parameter sample values in addition to η, such as a number of trees and/or a number of nodes per tree, for example. Of course, claimed subject matter is not limited to this example.

A ranking of quick links U(s) may be induced by computing \tilde{h}(s,u) for u∈U(s) to rank quick links by computation or prediction. A process, such as an embodiment, discussed above may pertain to ranking of quick links for web sites separately, with no information shared between similar web sites. A process, such as an embodiment, described below in contrast may employ similarities between different sites to determine relevant quick links.

In one example, two sites, s and s′, may relate to restaurants. It may be known, as a hypothetical example, that for sites of the class “restaurant,” quick link candidates with anchor or URL text containing the term “menu” may receive substantially the same relevance. That is, given two quick link candidates from sites in a common class, similar candidates may have similar relevance.

To exploit site classes, web sites may, for example, be classified. Classification of sites may be accomplished by clustering sites using a term-type representation, although this is merely one possible example. For example, wₛ may represent a |V|×1 term vector for site s. Terms may be extracted from anchor text or URL paths of links for various web sites. Web sites may subsequently be clustered using a diffusion wavelet approach, such as that discussed, for example, in “Multiscale analysis of document corpora based on diffusion models,” by C. Wang et al., In IJCAI 2009: Proceedings of the 21^{st} International Joint Conference on Artificial Intelligence, 2009. Of course, claimed subject matter is not limited to this approach. For example, a diffusion wavelet approach may entail construction of a term-term co-occurrence matrix from a bag-of-words representation of sites, e.g., by T^{T}T where T comprises a |S|×|V|“collection matrix.” By applying a diffusion wavelet process, wavelet “topic bases” may be obtained. A topic basis, φⁱ, may comprise a |V|×1 vector capturing behavior of terms in a particular class. A site s may be assigned to a class determined at least in part by argmaxᵢ (φᵢ,wₛ). An advantage may be that a fixed number of clusters need not be specified in advance. It should be noted that other clustering approaches may also be applied, of course. A partitioning of web sites may be performed to allow a system to evaluate or generate class-specific approaches, for example.

For a class c∈C, a class-specific model, h_{c}, which may leverage similarities between sites, may be trained. To train a class-specific approach, a Tree-based Domain Adaptation (TRADA) process may be utilized, as is discussed in “TRADA: tree based ranking function adaptation,” by K. Chen et al., in CIKM '08: Proceeding of the 17^{th} ACM conference on Information and knowledge management, 2008. Again, this is an illustrative example. Claimed subject matter is not limited to this approach.

A TRADA process may apply a generic approach as is discussed above for a possible embodiment. A TRADA process may subsequently modify a generic approach to reduce a loss function with respect to target signal sample values in a target domain. In one example, a target domain may comprise a class of sites. In other words, a goal may be to reduce a loss function overall, by constraining instances in class c,

\tilde{h}_{c}=argminₕ_{_{c}}_{∈H}_{_{c}}ε(h_{c},S_{c}^{t}) [4]

where S_{c}^{t} comprises a set of relevance-labeled sites of class c, for example.

Relation [4] is equivalent to relation [2] except for a set of training instances and an hypothesis space, H_{c}. Specifying H_{c} may comprise a useful part of a training technique. As discussed above, an approach may apply features of quick link candidates that allow similar quick link candidates to receive similar predictions. In an implementation, however, it may be that neither common features nor head features are able to capture semantic similarity of pairs of candidates. For example, a web site for which little information is known may not have sufficient common features from which to capture semantic similarity of pairs of candidates. Instead, however, semantic similarity may be managed via use of term features. “Term features,” as used herein may refer to words utilized as features. While common or head features may provide evidence for quick link relevance in general (e.g., “highly visited candidates are relevant”), term features may provide class-specific evidence (e.g., “for restaurants, candidates whose URL contains ‘menu’ are relevant”). As a result, in an implementation H_{c} may be specified such that

h_{c}(s,u)=\tilde{h}(s,u)+λ₀ƒ_{c}⁰(wᵤ)+ . . . +λ_{m′}ƒ_{c}^{m}′) [5]

where \tilde{h} comprises a generic model approximated with respect to relevance, fixed for h_{c}εH_{c}, and wᵤ represents a bag of words associated with candidate u. Except for an addition of \tilde{h}(s,u), relation [5] is identical to relation [3] in this example. As a result, TRADA may search H_{c} using a boosting approach, as described previously above for an embodiment. It is, of course, understood that values may be communicated as physical signals or stored as physical states.

Training signal or state information for classes may be desirable since relation [5] uses sparse term features, for example. If a number of classes is relatively large, collecting manual labels for web sites in a cluster may be relatively computationally expensive. To gather sufficient training, a bootstrap may be performed by labeling unlabeled sites or quick link candidates. That is, for a cluster, a generic model may be utilized to predict relevance scores of links in unlabeled sites. Pseudo-labels may be assigned to links, e.g., links in the top 30%, for example, may be relevant while links in the bottom 30% may be non-relevant. A TRADA process may be applied with pseudolabels. An advantage may be to relatively cheaply employ a number of homepages on the Internet or Web in an embodiment.

A dynamic quick links task may allow a system to adjust to a ranking of quick links depending at least in part on a context of a user browsing a website. In an example, context may be characterized by a current page uεU(s). Just as click activity of users may assist in predicting static quick link rankings, browsing activity of users may assist in predicting dynamic quick links rankings. For example, a user may read a “menu” page for a restaurant. If a system has observed other visitors navigating to a “directions” page immediately after reading a “menu” page, evidence supports a relevance of a “directions” page in this context.

Scarcity of user activity for tail sites may be addressed above with respect to static quick links. Scarcity of user browsing activity may also be addressed with respect to dynamic quick links. An approach to handling dynamic quick links similar in concept to that for handling static quick links. For example, signal or state information may be used from semantically related quick link candidates. For example, a system may cluster quick link candidates within site classes C. A quick link clustering process may utilize term-type representations, potentially resulting in clustering links with related text (e.g., “directions” or “location”), such as anchor text or words in URL paths. Although an unsupervised clustering method could be performed, user activity may be accessed that may, for example, direct or at least partially guide clustering. Given two web sites in the same site class, for example, two links may be semantically similar if they share a similar number of visits. So, given two arbitrary restaurants, two “menu” quick links may be expected to receive a comparable number of visits. In practice, a number of visits may be normalized by a number of site visits so that links may be compared, such as between head, torso, or tail sites.

A representation may be term-type in a manner so that supervision may comprise a real valued operation, as explained above, for example. A cluster method may be utilized, such as a supervised Latent Dirichlet allocation (LDA), as is discussed in “Supervised topic models,” D. Biel et al., Advances in Neural Information Processing Systems 20, 2008. Of course, claimed subject matter is not limited to this approach. Supervised LDA may project one or more training instances into a k-dimensional “topic space,” represented as a multinomial distribution over topics. In other words, for a u, a distribution p(c/u) over all c∈C may exist.

After representations or links have been assessed, browsing behaviors between links or representations may be investigated. A Markov assumption about link transition may be made, whereby a class of a next link to be browsed may depend at least in part on a class of a current link. If B represents user browsing activity information encoded as URL transitions, an empirical distribution of transition probabilities from quick link class cᵢ to cⱼ may be computed as,

$${P}_{ij} = \frac{{\sum }_{u \to {u}^{′} ∈ B} p ( {c}_{i} \vert u ) p ( {c}_{j} \vert {u}^{′} )}{{\sum }_{{c}_{k}} {\sum }_{u \to {u}^{′} ∈ B} p ( {c}_{i} \vert u ) p ( {c}_{j} \vert {u}^{′} )}$$

Although an estimated random walk matrix may represent a browsing feature, it may be beneficial to encode multiple browsing features. For example, some users may prefer shortcuts from one link to another link that is a few hops away instead of going through several intermediate links that most users may follow. If so, a random walk matrix may be constructed as follows:

$$R = \frac{1}{Z} {\sum }_{a = 1}^{T} {ϒ}^{a - 1} {P}^{a}$$

where Z comprises a normalization factor, γ comprises a shrinkage parameter, and T comprises a number of hops. Given a quick link transition matrix, quick link candidates may be ranked. The relation zᵤ=[p(c₀/u), p(c₁/u), . . . , p(cₖ₋₁/u) may comprise a k×1 topic vector of a current URL being currently viewed by a particular individual. Scores for possible classes of a next quick link may be computed as, \tilde{z}\tilde{zᵤ}=R^{T}zᵤ.

To find links relevant to u, a system may compute a cosine similarity between \tilde{z}\tilde{zᵤ} and topic vectors of a v∈U(s). This similarity may capture textual properties of quick link candidates. Therefore, a cosine similarity may be combined with a GBDT prediction, which may be based at least in part on additional types of features to achieve

ƒ(s,u,v)=τh(s,v)+(1−τ)(\tilde{zᵤ},zᵥ)

where τ comprises a parameter. Candidate links may subsequently be ranked by ƒ(s,u,v).

As discussed above, traffic-type link suggestions, while effective, may be improved by using non-traffic-type user activity signal or state information as well as clustering.

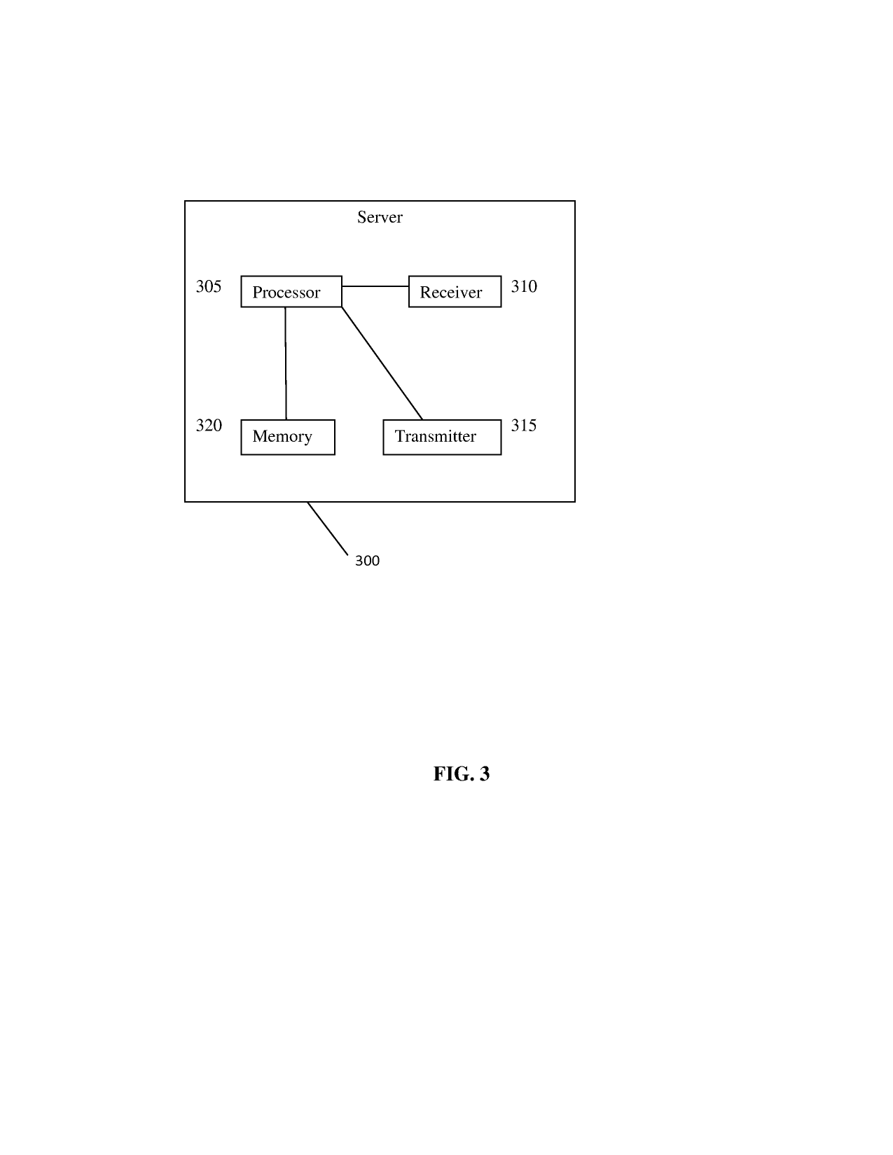

FIG. 3 illustrates a server 300 according to an implementation. Server 300 may include a processor 305, a receiver 310, a transmitter 315, and a memory 320, to name just a few among possible components of server 300. Signal or state information relating to various web sites may be received at receiver 310. Signal or state information may be received from a server or other entity crawling the Internet to determine various links within a web site, for example. Signal or state information may be stored in memory 320, for example. Processor 305 may perform machine learning or may otherwise classify websites and determine quick link suggestions as discussed above. Transmitter 315 may, for example, transmit one or more signals containing quick links to a user for display on the user's computer monitor.

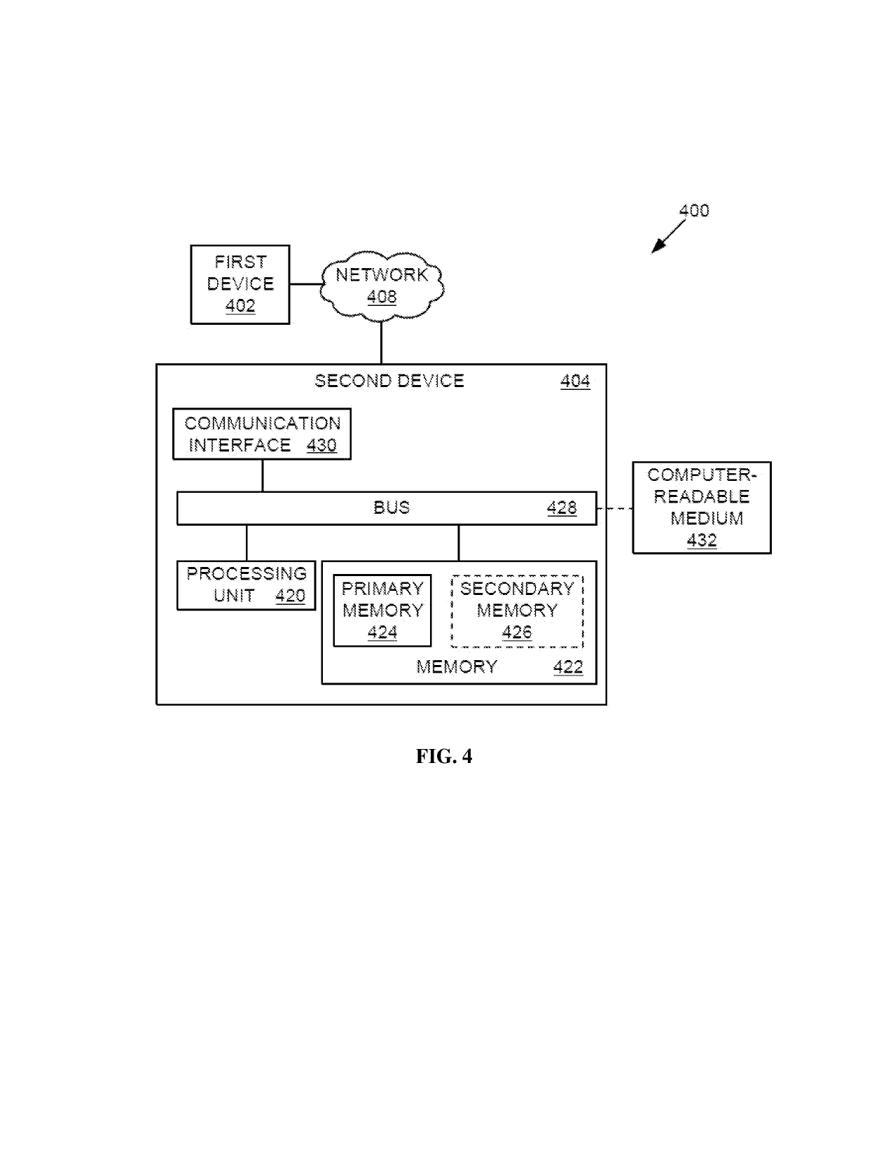

FIG. 4 is a schematic diagram illustrating a computing environment system 400 that may include one or more devices to display web browser information according to one implementation. System 400 may include, for example, a first device 402 and a second device 404, which may be operatively coupled together through a network 408.

First device 402 and second device 404, as shown in FIG. 4, may be representative of any device, appliance or machine that may be configurable to exchange signals over network 408. First device 402 may be adapted to receive a user input signal from a program developer, for example. First device 402 may comprise a server capable of transmitting one or more quick links to second device 404. By way of example but not limitation, first device 402 or second device 404 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or storage service provider/system, a network service provider/system, an Internet or intranet service provider/system, a portal or search engine service provider/system, a wireless communication service provider/system; or any combination thereof.

Similarly, network 408, as shown in FIG. 4, is representative of one or more communication links, processes, or resources to support exchange of signals between first device 402 and second device 404. By way of example but not limitation, network 408 may include wireless or wired communication links, telephone or telecommunications systems, buses or channels, optical fibers, terrestrial or satellite resources, local area networks, wide area networks, intranets, the Internet, routers or switches, and the like, or any combination thereof.

It is recognized that all or part of the various devices and networks shown in system 400, and the processes and methods as further described herein, may be implemented using or otherwise include hardware, firmware, software, or any combination thereof (other than software per se).

Thus, by way of example but not limitation, second device 404 may include at least one processing unit 420 that is operatively coupled to a memory 422 through a bus 428.

Processing unit 420 is representative of one or more circuits to perform at least a portion of a computing procedure or process. By way of example but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 is representative of any storage mechanism. Memory 422 may include, for example, a primary memory 424 or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420.

Secondary memory 426 may include, for example, the same or similar type of memory as primary memory or one or more storage devices or systems, such as, for example, a disk drive, an optical disc drive, a tape drive, a solid state memory drive, etc. In certain implementations, secondary memory 426 may be operatively receptive of, or otherwise able to couple to, a computer-readable medium 432. Computer-readable medium 432 may include, for example, any medium that can carry or make accessible data signals, code or instructions for one or more of the devices in system 400.

Second device 404 may include, for example, a communication interface 430 that provides for or otherwise supports operative coupling of second device 404 to at least network 408. By way of example but not limitation, communication interface 430 may include a network interface device or card, a modem, a router, a switch, a transceiver, or the like.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

While certain techniques have been described and shown herein using various methods and systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to particular examples disclosed, but that claimed subject matter may also include all implementations falling within the scope of the appended claims, or equivalents thereof.

What is claimed is:

1. A method, comprising:
ranking potential quick link candidates; and
selecting candidate quick links based at least in part on the respective rankings of potential quick link candidates within websites and across websites.

2. The method of claim 1, and further comprising: transmitting one or more electronic signals to a computing platform via an electronic communication network to present one or more of the candidate quick links.

3. The method of claim 1, wherein the ranking potential quick link candidates is performed within websites based at least in part on common features.

4. The method of claim 1, wherein the ranking potential quick link candidates is performed-across websites based at least in part on term features.

5. The method of claim 1, wherein the websites include head sites, tail sites or a combination thereof.

6. The method of claim 1, further comprising selecting candidate dynamic quick links based at least in part on estimates of link transition probabilities.

7. The method of claim 1, wherein one or more of the quick link candidates for one of the websites comprises a link to a web page associated with the one of the websites.

8. The method of claim 1, further comprising ranking potential quick link candidates based at least in part on user behavior-type features.

9. The method of claim 1, wherein the common features comprise Uniform Resource Locator (URL) features.

10. The method of claim 1, wherein the common features comprise anchor text-type features.

11. An apparatus, comprising: a computing platform;
said computing platform having a capability to select candidate quick links based at least in part on respective rankings of potential quick link candidates within websites and across websites.

12. The apparatus of claim 11, wherein said computing platform further has a capability to rank potential quick link candidates based at least in part on processing of user browsing activity.

13. The apparatus of claim 11, wherein the common features comprise Uniform Resource Locator (URL) features.

14. The apparatus of claim 11, wherein the common features comprise anchor text-type feature.

15. An article, comprising:
a storage medium comprising machine-readable instructions executable by a special purpose apparatus to:
ranking potential quick link candidates; and
selecting candidate quick links based at least in part on user web browser information and the respective rankings of potential quick link candidates within websites and across websites.

16. The article of claim 15, wherein the machine-readable instructions are further executable to select candidate dynamic quick links based at least in part on estimates of link transition probabilities.

17. The article of claim 15, wherein the machine-readable instructions are further executable to rank potential quick link candidates within websites based at least in part on common features.

18. The article of claim 15, wherein the machine-readable instructions are further executable to rank potential quick link candidates across websites based at least in part on term features.

19. The article of claim 15, wherein the user browser information comprises a search engine query.

20. The article of claim 15, wherein the common features comprise anchor text-type features.
